(19) United States
(12) Patent Application Publication
(10) Pub. No.: US 2018/0128145 A1
(43) Pub. Date: May 10, 2018

(54) METHOD AND SYSTEM FOR AN EXHAUST DIVERTER VALVE

(71) Applicant: Ford Global Technologies, LLC, Dearborn, MI (US)

(72) Inventors: Michael James Uhrich, West Bloomfield, MI (US); Joseph Norman Ulrey, Dearborn, MI (US); Ross Dykstra Pursifull, Dearborn, MI (US)

(21) Appl. No.: 15/347,520

(22) Filed: Nov. 9, 2016

(51) Int. Cl. F01N 3/20; F01N 1/16; F02M 26/21; F02M 26/35; F02M 26/53; F02D 41/00; F02D 41/02; F02D 41/26; F02D 41/22; G01M 15/04

(52) U.S. Cl. CPC F01N 3/2053; F01N 1/166; F02M 26/21; F02M 26/35; G01M 15/048; F02D 41/0077; F02D 41/0235; F02D 41/26; F02D 41/221; F02M 26/53

(57) ABSTRACT

Methods and systems are provided for diagnosing an exhaust diverter valve in an engine system and adjusting the diverter valve position to regulate vehicle exhaust noise so that the same exhaust diverter valve can be used to reduce emissions and expedite engine heating during a cold-start as well as regulate exhaust noise. In one example, a method for diverter valve diagnostics may include determining diverter valve degradation during an engine cold-start, when the diverter valve is closed, based on the change in the temperature upstream of the diverter valve from the temperature at engine start. In another example, a method for exhaust noise adjustment may include adjusting the diverter valve position to provide a target exhaust backpressure that produces a desired change in vehicle exhaust noise.

### FIELD

The present description relates generally to methods and systems for controlling and diagnosing an exhaust diverter valve in an engine system of a vehicle.

### BACKGROUND/SUMMARY

An engine system of a vehicle may be configured with an exhaust diverter valve, which may serve a variety of functions. As one example, the exhaust diverter valve may be used to selectively route engine exhaust to a bypass passage configured with an ancillary exhaust after-treatment device. For example, the exhaust diverter valve may route exhaust through a gasoline particulate filter or HC trap in the bypass passage during a cold-start to reduce exhaust emissions during engine and catalyst warm-up. As another example, the exhaust diverter valve may route exhaust through a heat exchanger in the bypass passage to recover exhaust heat for engine heating as well for cooling exhaust before exhaust gas recirculation to an intake manifold. By using an exhaust diverter valve to expedite engine heating and exhaust catalyst activation, fuel economy is also increased.

The inventors herein have recognized that the exhaust diverter valve may also be used to regulate exhaust noise. For example, by adjusting the position of the diverter valve to vary the exhaust backpressure, an exhaust noise characteristic may be customized to an operator's preference. By relying on the diverter valve to provide the desired exhaust noise control, the use of dedicated noise controlling devices, such as mufflers, resonators, sound proofing material, noise cancelling software, etc., which tend to be heavy and expensive, may be reduced.

As such, for an exhaust diverter valve to serve the various functions reliably, the functionality of the diverter valve may be periodically tested. For example, if the diverter valve is degraded and exhaust gas is leaking past the diverter valve, tailpipe emissions may be affected. Various approaches are provided for diagnosing an exhaust diverter valve. For example, as shown by Melzig in U.S. Pat. No. 9,116,075, exhaust diverter valve degradation may be inferred based on an exhaust pressure profile estimated via a pressure sensor located upstream of the exhaust diverter valve. Therein, as the pre-valve pressure decreases from an expected pressure, the inferred amount of diverter valve leakage may be increased. In another example, as shown by Takakura et al. in U.S. Pat. No. 6,477,830, the diverter valve may be diagnosed based on a change in the exhaust humidity profile. In still further examples, the exhaust diverter valve may be diagnosed based on the profile of an exhaust temperature measured downstream of the diverter valve.

However, the inventors herein have recognized potential issues with such systems. As one example, the above discussed approaches may not be reliable due to insufficient signal-to-noise separation. For example, if the ancillary device in the exhaust bypass passage has low backpressure (such as may occur when the bypass passage includes a heat exchanger), the signal-to-noise ratio of the pressure measured by the pressure sensor upstream of the diverter valve may be low. Due to the low statistical separation of the nominal signal-to-noise from a diagnostic threshold, the pressure-based diagnostic method may be unreliable. As another example, due to hot exhaust flowing out of the tailpipe, noise may be unintentionally introduced into a diagnostic method relying on the exhaust temperature estimated downstream of the exhaust diverter valve. If there is a false positive indication that the diverter valve is functional (that is, the diverter valve is incorrectly deemed to be functional when leakage is actually occurring), tailpipe emissions may rise above threshold levels. In addition, fuel economy may be degraded.

In one example, the issues described above may be at least partly addressed by a method for an engine comprising, responsive to an engine cold-start condition, operating with a diverter valve closed to divert exhaust gas from a main exhaust passage, downstream of an exhaust catalyst, into a bypass housing an ancillary device; and indicating degradation of the diverter valve based on a change in exhaust temperature determined upstream of the diverter valve for a duration since engine start. After diagnosing the diverter valve, an opening of the valve may be adjusted to meet an operator-indicated exhaust noise request. In this way, a robust exhaust diverter valve diagnostic method may be provided with a higher signal-to-noise ratio. In addition, the same diverter valve may be used for expediting engine heating and catalyst activation as well as for exhaust noise regulation.

As one example, during an engine cold-start, an exhaust diverter valve may be actuated closed to divert exhaust gas from a main exhaust passage, downstream of an exhaust catalyst, into a tailpipe via a bypass passage housing an ancillary device, such as a heat exchanger. An exhaust temperature measured upstream of the diverter valve may be monitored at the time of closing the diverter valve and for a duration thereafter. For example, the temperature may be monitored continuously over the duration or intermittently, at fixed intervals. If the exhaust temperature measured upstream of the diverter valve changes (e.g., rises) by less than a threshold amount, it may be inferred that the diverter valve is not degraded and exhaust is not leaking past the valve. If the exhaust temperature measured upstream of the diverter valve changes by more than the threshold amount, it may be inferred that the diverter valve is degraded and a degree of exhaust leakage past the valve may be determined based on the degree of rise in exhaust temperature over the duration. In this way, the diverter valve may be opportunistically diagnosed based on the pre-valve exhaust temperature profile while the valve is operated during the engine start.

Upon confirming that the diverter valve is functional, and after catalyst light-off is achieved, the diverter valve may be used for various other functions such as for adjusting vehicle exhaust noise responsive to an operator exhaust noise request. Therein, based on a request for noise amplification or noise reduction, a position of the diverter valve may be varied to provide a target exhaust backpressure upstream of the diverter valve. For example, when the requested adjustment includes exhaust noise amplification, the exhaust diverter valve may be opened to a greater degree to provide a lower target backpressure, and when the requested adjustment includes exhaust noise reduction, the exhaust diverter valve may be closed to a greater degree to provide a higher target backpressure.

In this way, an exhaust diverter valve can be reliably and opportunistically diagnosed during an engine cold-start operation, and thereafter used to regulate exhaust noise. The technical effect of diagnosing the diverter valve based on an exhaust temperature profile measured upstream of a closed diverter valve is that a signal-to-noise ratio separation from a diagnostics threshold can be increased. In particular, by measuring the upstream temperature after closing the valve and diverting exhaust through an ancillary device in an exhaust bypass passage, a higher signal-to-noise ratio may be achieved even when a pressure difference across the ancillary device is lower. By increasing the accuracy of the diagnosis, the likelihood of false positive valve diagnostics is reduced, improving engine cold-start emissions. By using the same diverter valve for enabling exhaust heat recovery, engine heating, and exhaust noise control, component reduction benefits are achieved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows an example embodiment of an engine system, including an exhaust heat exchange system, operating in a first mode.

FIG. 1B shows an example embodiment of an engine system, including an exhaust heat exchange system, operating in a second mode.

FIG. 1C shows an example embodiment of an engine system, including an exhaust heat exchange system, operating in a third mode.

FIG. 2 shows a table summarizing the different modes of operation of the exhaust heat exchange system of FIGS. 1A-1C.

FIG. 3 shows a flow chart illustrating an example method that may be implemented for adjusting exhaust flow through the exhaust heat exchange system of FIGS. 1A-1C.

FIG. 4 shows a flow chart illustrating an example method that may be implemented for diagnosing an exhaust diverter valve of the exhaust heat exchange system of FIGS. 1A-1C.

FIG. 5 is a graph demonstrating the relationship between exhaust diverter valve leakage and the exhaust temperature measured upstream of the diverter valve.

FIG. 6 shows a flow chart illustrating an example method that may be implemented for adjusting an exhaust system diverter valve to regulate exhaust noise.

FIG. 7 shows an example of diagnosing an exhaust diverter valve during an engine cold-start and adjusting the diverter valve thereafter to provide a desired engine exhaust noise profile.

### DETAILED DESCRIPTION

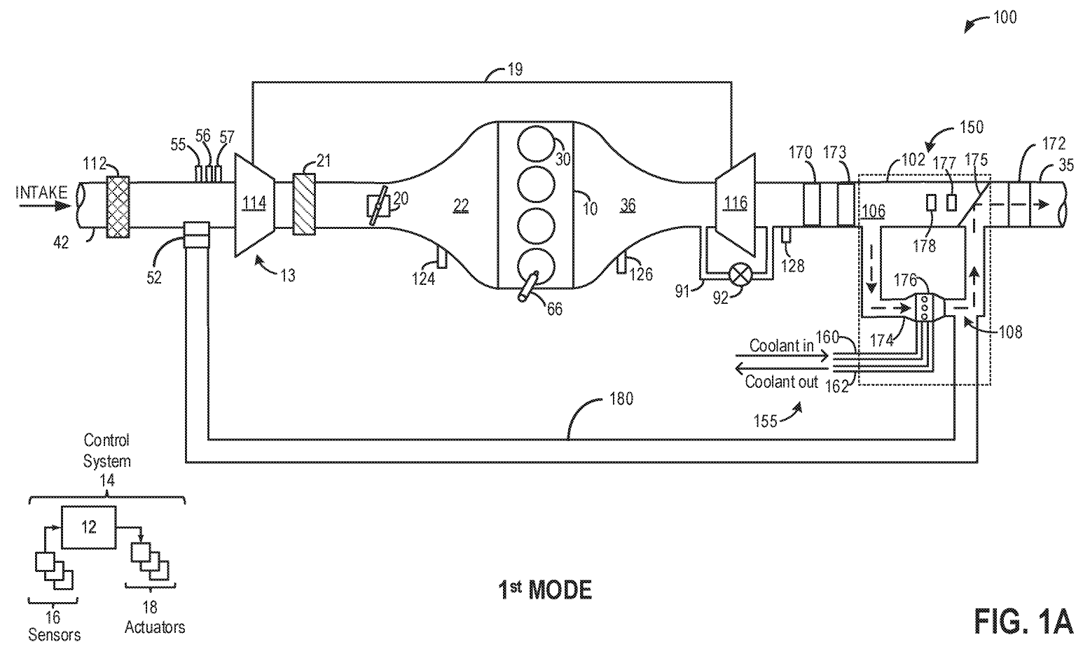

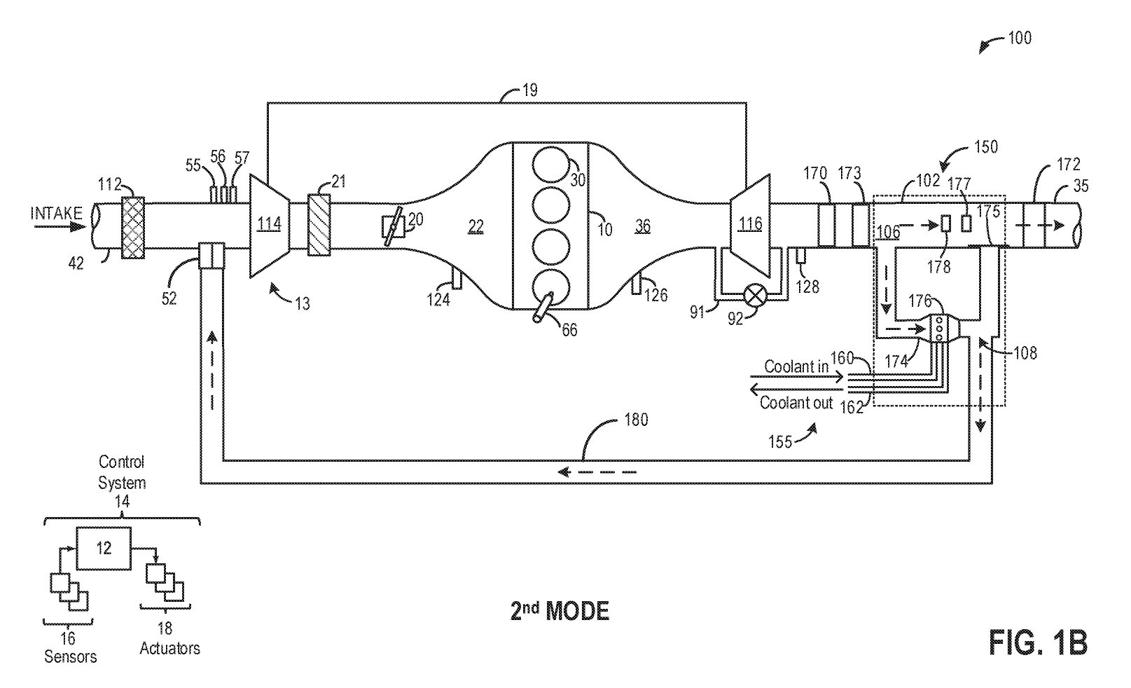

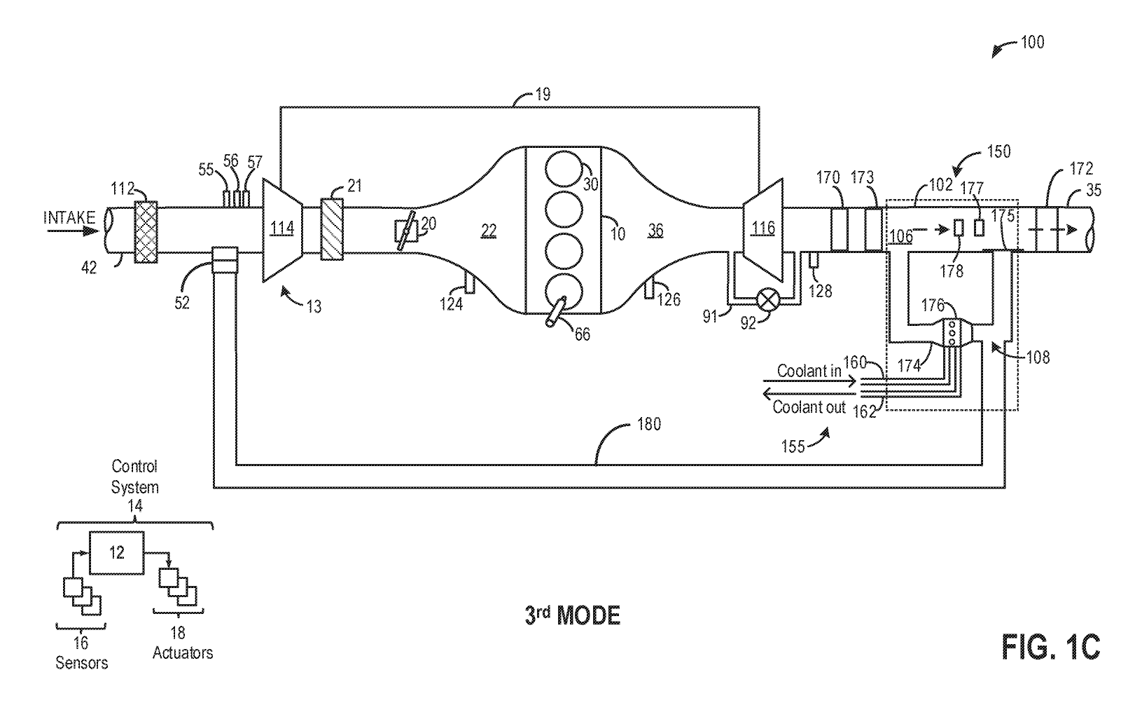

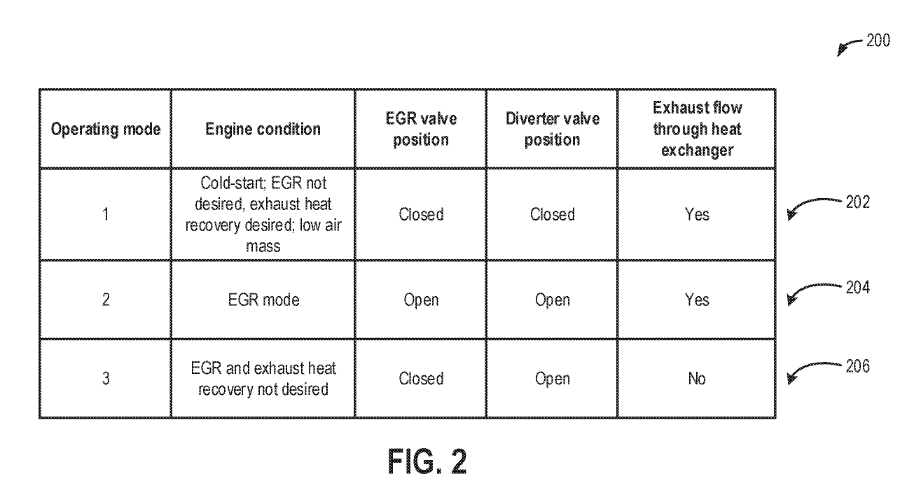

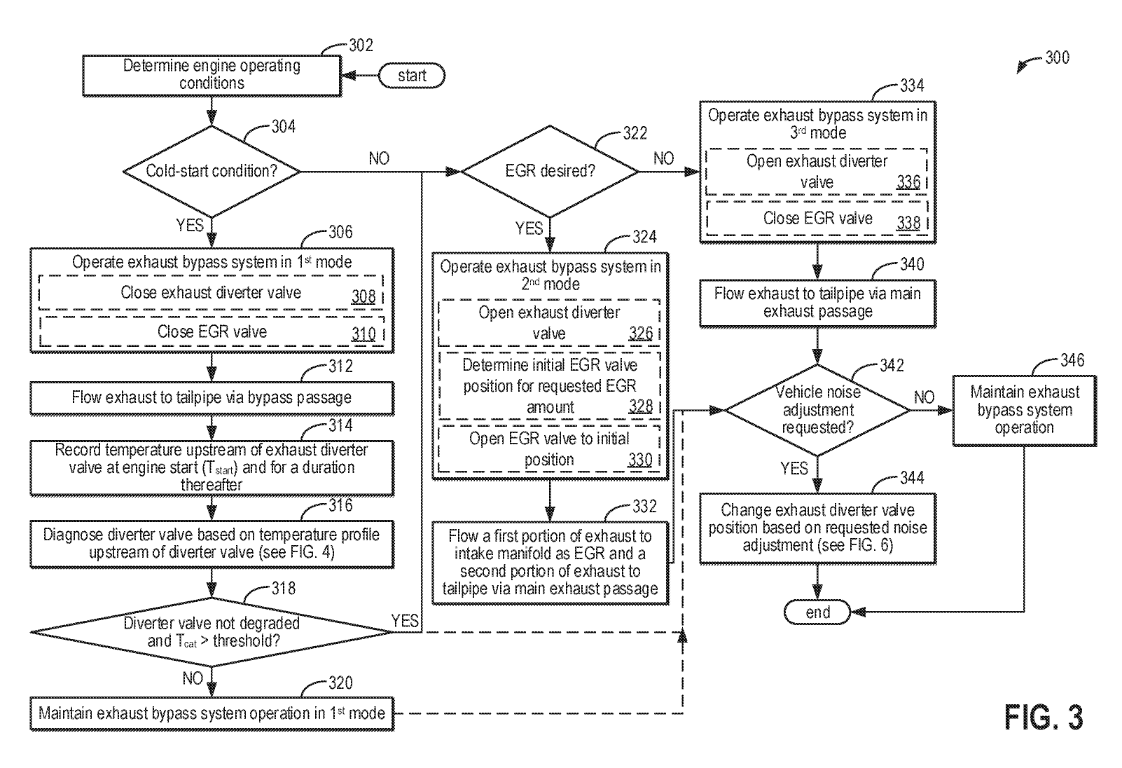

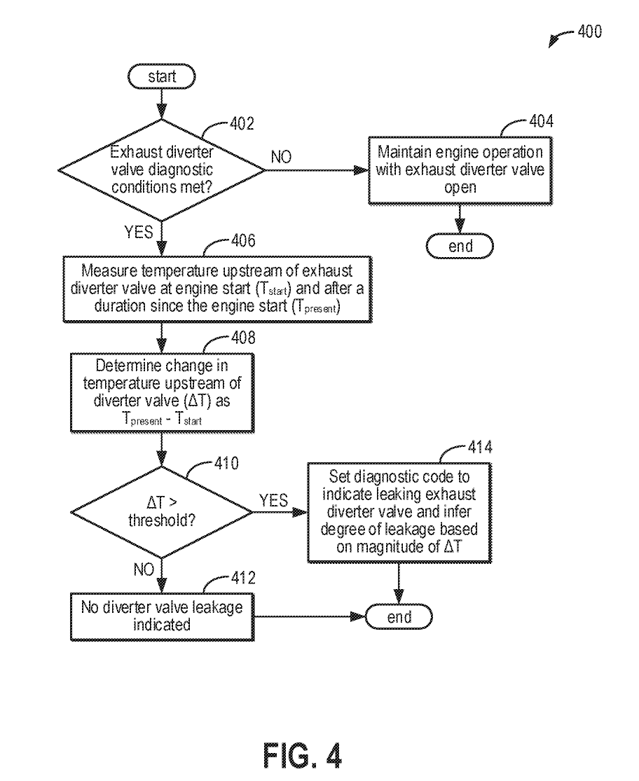

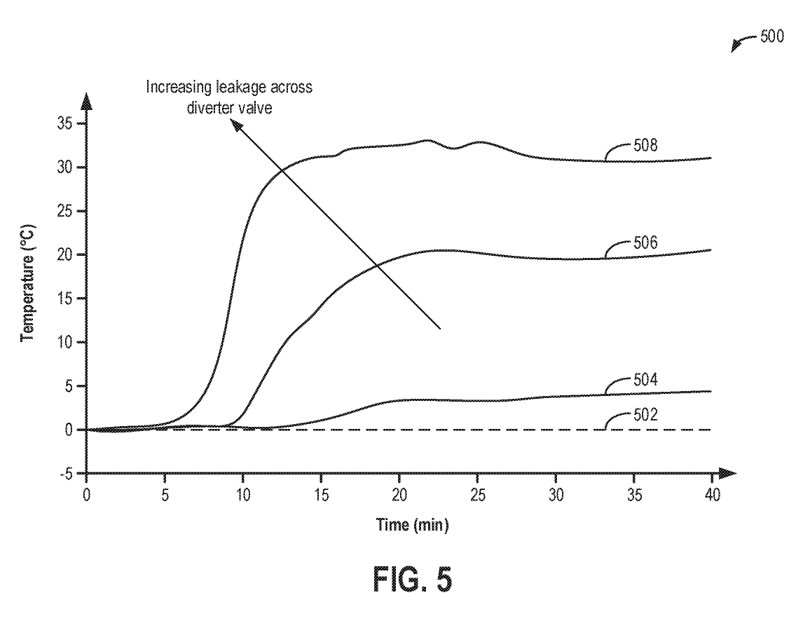

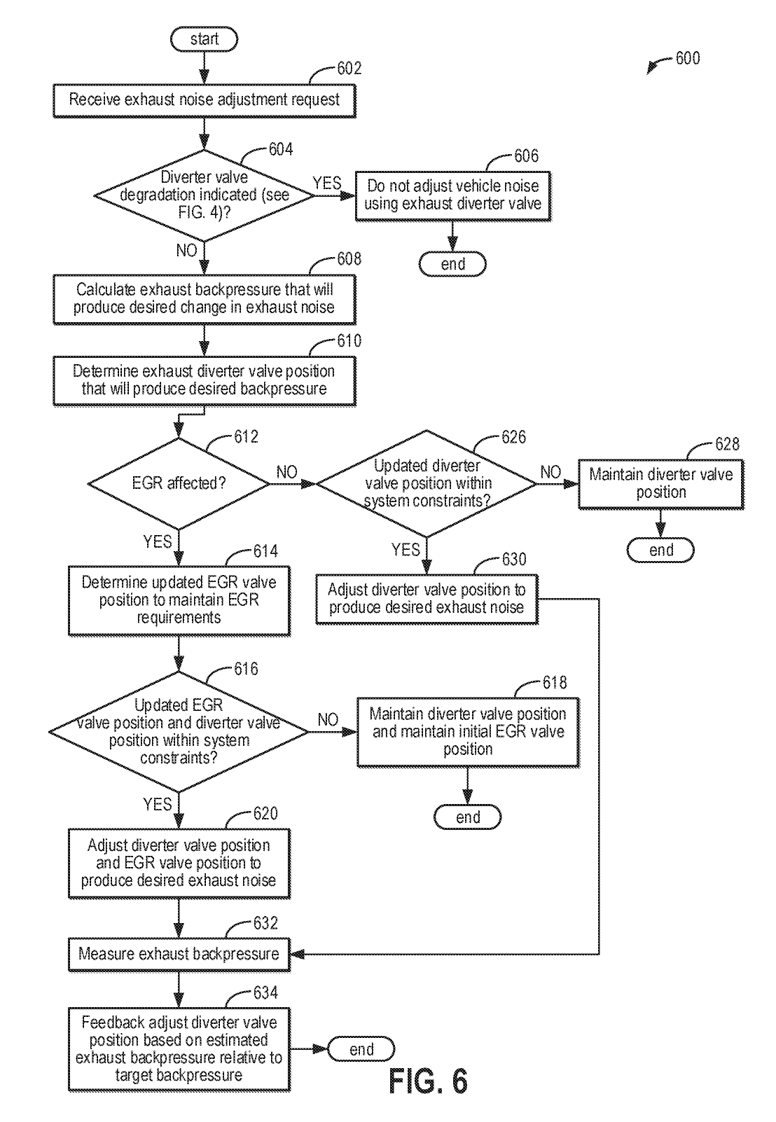

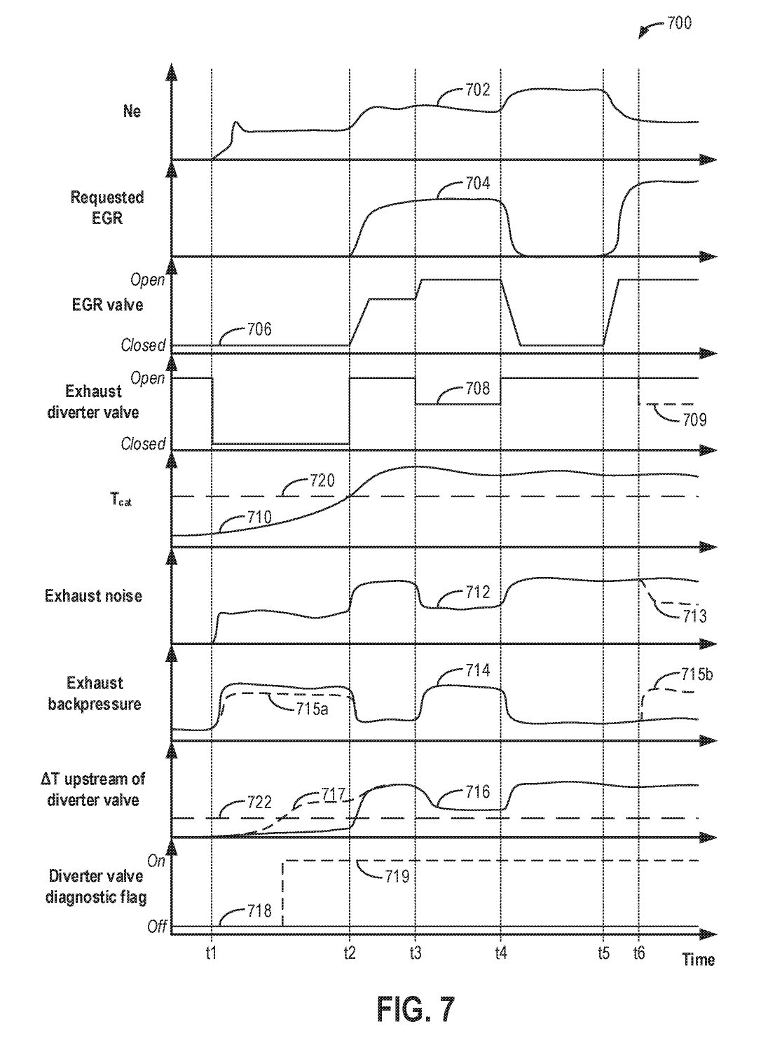

The following description relates to systems and methods for diagnosing an exhaust diverter valve and controlling the exhaust diverter valve to adjust exhaust noise. As a non-limiting example, the exhaust diverter valve is shown configured in an exhaust heat exchange system, with different modes of operation of the exhaust heat exchange system shown in FIGS. 1A-1C. The exhaust heat exchange system may include a single heat exchanger (coupled to a bypass passage) for exhaust gas heat recovery and exhaust gas recirculation (EGR) cooling. The different modes of operation of the example engine system are tabulated in FIG. 2. An engine controller may be configured to perform control routines, such as the example routines of FIGS. 3, 4, and 6, to control the operation of the exhaust heat exchange system, including the exhaust diverter valve. Exhaust diverter valve leakage may be determined based on an exhaust temperature profile measured upstream of the diverter valve during an engine cold-start, as described in the example method of FIG. 4. An example temperature profile for an exhaust diverter valve with no leak, a small leak, and a large leak is illustrated in FIG. 5. After diagnosing the diverter valve and after completing catalyst light-off, exhaust noise may be adjusted by changing the position of the diverter valve to provide a target backpressure, for example, using the method of FIG. 6. An example of exhaust diverter valve diagnostics and exhaust noise control is shown in FIG. 7.

FIG. 1A schematically shows aspects of an example engine system 100, including an engine 10. In one example, engine system 100 is coupled in a propulsion system, such as a vehicle configured for on-road travel. In the depicted embodiment, engine 10 is a boosted engine coupled to a turbocharger 13 including a compressor 114 driven by a turbine 116. Specifically, fresh air is introduced along intake passage 42 into engine 10 via air cleaner 112 and flows to compressor 114. The compressor may be any suitable intake-air compressor, such as a motor-driven or driveshaft driven supercharger compressor. In engine system 10, the compressor is a turbocharger compressor mechanically coupled to turbine 116 via a shaft 19, the turbine 116 driven by expanding engine exhaust.

As shown in FIG. 1, compressor 114 is coupled through charge-air cooler (CAC) 21 to throttle valve 20. Throttle valve 20 is coupled to engine intake manifold 22. From the compressor, the compressed air charge flows through the charge-air cooler 21 and the throttle valve to the intake manifold. In the embodiment shown in FIG. 1A, the pressure of the air charge within the intake manifold is sensed by manifold air pressure (MAP) sensor 124.

One or more sensors may be coupled to an inlet of compressor 114. For example, a temperature sensor 55 may be coupled to the inlet for estimating a compressor inlet temperature, and a pressure sensor 56 may be coupled to the inlet for estimating a compressor inlet pressure. As another example, a humidity sensor 57 may be coupled to the inlet for estimating a humidity of aircharge entering the compressor. Still other sensors may include, for example, air-fuel ratio sensors, etc. In other examples, one or more of the compressor inlet conditions (such as humidity, temperature, pressure, etc.) may be inferred based on engine operating conditions. In addition, when EGR is enabled, the sensors may estimate a temperature, pressure, humidity, and air-fuel ratio of the aircharge mixture, which includes fresh air, recirculated compressed air, and exhaust residuals received at the compressor inlet.

A wastegate actuator 92 may be actuated open to dump at least some exhaust pressure from upstream of the turbine to a location downstream of the turbine via wastegate 91. Turbine speed can be reduced by reducing exhaust pressure upstream of the turbine, which in turn helps to reduce compressor surge.

Intake manifold 22 is coupled to a series of combustion chambers 30 through a series of intake valves (not shown). The combustion chambers are further coupled to exhaust manifold 36 via a series of exhaust valves (not shown). In the depicted embodiment, a single exhaust manifold 36 is shown. However, in other embodiments, the exhaust manifold may include a plurality of exhaust manifold sections. Configurations having a plurality of exhaust manifold sections may enable effluent from different combustion chambers to be directed to different locations in the engine system.

In one embodiment, each of the exhaust and intake valves may be electronically actuated or controlled. In another embodiment, each of the exhaust and intake valves may be cam actuated or controlled. Whether electronically actuated or cam actuated, the timing of exhaust and intake valve opening and closure may be adjusted based on a desired combustion and emissions-control performance.

Combustion chambers 30 may be supplied with one or more fuels, such as gasoline, alcohol fuel blends, diesel, biodiesel, compressed natural gas, etc., via injector 66. Fuel may be supplied to the combustion chambers via direct injection, port injection, throttle valve-body injection, or any combination thereof. In the combustion chambers, combustion may be initiated via spark ignition and/or compression ignition.

As shown in FIG. 1A, exhaust from the one or more exhaust manifold sections may be directed to turbine 116 to drive the turbine. The combined flow from the turbine and the wastegate then flows through emission control devices 170 and 173. In one example, the first emission control device 170 may be a light-off catalyst, and the second emissions control device 173 may be an underbody catalyst. In general, the exhaust after-treatment devices 170 and 173 are configured to catalytically treat the exhaust flow and thereby reduce an amount of one or more substances in the exhaust flow. For example, the exhaust after-treatment devices 170 and 173 may be configured to trap NOₓ from the exhaust flow when the exhaust flow is lean and to reduce the trapped NOₓ when the exhaust flow is rich. In other examples, the exhaust after-treatment devices 170 and 173 may be configured to disproportionate NOₓ or to selectively reduce NOₓ with the aid of a reducing agent. In still other examples, the exhaust after-treatment devices 170 and 173 may be configured to oxidize residual hydrocarbons and/or carbon monoxide in the exhaust flow. Different exhaust after-treatment catalysts having any such functionality may be arranged in wash coats or elsewhere in the exhaust after-treatment stages, either separately or together. In one example embodiment, exhaust after-treatment device 173 is an exhaust underbody catalyst with a regeneratable gasoline particulate filter (GPF) coating configured to trap and oxidize soot particles in the exhaust flow. Regeneration of the GPF coating of the underbody catalyst may be regulated based on the output of temperature sensor 177. For example, when the inferred particulate matter load of the GPF coating is higher than a threshold, engine fueling and/or spark timing may be adjusted to raise the exhaust temperature high enough to burn off the accumulated soot. As an example, air-fuel ratio enrichment and/or spark retard may be provided to raise the estimated exhaust temperature above a threshold temperature, the threshold temperature selected based on the inferred soot load.

Downstream of the second emission control device 173, exhaust may flow to muffler 172 via one or more of a main exhaust passage 102 and a bypass passage 174. For example, all or part of the treated exhaust from the exhaust after-treatment devices 170 and 173 may be released into the atmosphere via main exhaust passage 102 after passing through a muffler 172. Alternatively, all or part of the treated exhaust from the exhaust after-treatment devices 170 and 173 may be released into the atmosphere via an exhaust heat exchange system 150 coupled to the main exhaust passage. The heat exchange system 150 can be operated for exhaust heat recovery for use in engine heating as well as for EGR cooling. The components of the heat exchange system also enable exhaust heat recovery and EGR cooling to be concurrently performed using a single heat exchanger, as elaborated below.

Bypass passage 174 of the exhaust heat exchange system 150 may be coupled to the main exhaust passage 102 downstream of the second emission control device 173 at junction 106. The bypass passage 174 may extend from downstream of the second emission control device 173 to upstream of muffler 172. Bypass passage 174 may be arranged parallel to the main exhaust passage 102. An ancillary device may be coupled in the bypass passage. In the present example, a heat exchanger 176 is shown coupled to bypass passage 174 to cool the exhaust passing through the bypass passage 174. In one example, heat exchanger 176 is a water-gas exchanger. An engine coolant system 155 may be fluidically coupled to the exhaust heat exchanger 176 for exhaust heat recovery and EGR cooling. A coolant of the coolant system may flow through the heat exchanger via a coolant inlet line 160 and after circulating through the heat exchanger, the coolant may return to the engine or may be routed to a heater core via a coolant outlet line 162. It will be appreciated that in alternate examples, one or more other ancillary devices may be coupled to bypass passage 174. For example, the ancillary device may include a gasoline particulate filter or a hydrocarbon trap.

Returning to heat exchange system 150, EGR delivery passage 180 may be coupled to the exhaust bypass passage 174 at junction 108, downstream of heat exchanger 176, to provide low pressure EGR to the engine intake manifold upstream of compressor 114. In this way, exhaust cooled via heat exchanger 176 can be recirculated to the engine intake. In further embodiments, the engine system may include a high pressure EGR flow path wherein exhaust gas is drawn from upstream of turbine 116 and recirculated to the engine intake manifold downstream of compressor 114. One or more sensors may be coupled to EGR passage 180 for providing details regarding the composition and condition of the EGR. For example, a temperature sensor may be provided for determining a temperature of the EGR, a pressure sensor may be provided for determining a pressure of the EGR, a humidity sensor may be provided for determining a humidity or water content of the EGR, and an air-fuel ratio sensor may be provided for estimating an air-fuel ratio of the EGR. Alternatively, EGR conditions may be inferred by the one or more temperature, pressure, and humidity sensors 55-57 coupled to the compressor inlet.

A diverter valve 175 coupled to the junction of the main exhaust passage 102 and an outlet of the bypass passage 174, downstream of heat exchanger 176, may be used to regulate the flow of exhaust through the bypass passage 174. A position of the diverter valve may be adjusted responsive to signals received from an engine controller to operate the exhaust heat exchange system in a selected mode of operation. In one example, the diverter valve may be actuated to a first, fully closed position to allow exhaust to flow from second emission control device 173 to a tailpipe 35 via exhaust bypass passage 174, thereby enabling the heat exchange system to be operated in a first mode where exhaust heat recovery is provided. As another example, the diverter valve may be actuated to a second, fully open position to direct all exhaust to the tailpipe via the main exhaust passage while disabling exhaust flow from second emission control device 173 to the tailpipe 35 via exhaust bypass passage 174, as elaborated herein with reference to FIG. 1C. A temperature sensor 177 and a pressure sensor 178 may be coupled to main exhaust passage 102 upstream of diverter valve 175 and downstream of junction 106. Exhaust temperature measured by temperature sensor 177 may be used for diagnosing diverter valve leakage, as described with reference to FIG. 4. The exhaust pressure sensed upstream of diverter valve 175 may be used to adjust the position of the diverter valve to regulate exhaust noise, as described with reference to FIG. 6.

An EGR valve 52 may be coupled to EGR passage 180 at the junction of EGR passage 180 and intake passage 42. EGR valve 52 may be configured as a continuously variable valve or as an on/off valve. Depending on operating conditions, such as engine temperature, a portion of the exhaust may be diverted through exhaust bypass passage 174 and thereon to the inlet of compressor 114 via EGR passage 180 and EGR valve 52. By concurrently adjusting a position of EGR valve 52 with diverter valve 175 fully open, the heat exchanger system may be operated in a second mode wherein EGR is provided to the engine intake passage 42, as elaborated herein with reference to FIG. 1B.

Engine system 100 may further include control system 14. Control system 14 is shown receiving information from a plurality of sensors 16 (various examples of which are described herein) and sending control signals to a plurality of actuators 18 (various examples of which are described herein). As one example, sensors 16 may include temperature sensor 177 and pressure sensor 178 coupled to main exhaust passage 102 upstream of exhaust diverter valve 175 and downstream of exhaust catalyst 173, exhaust gas sensor 126 located upstream of turbine 116, MAP sensor 124, exhaust temperature sensor 128, compressor inlet temperature sensor 55, compressor inlet pressure sensor 56, and compressor inlet humidity sensor 57. Other sensors, such as additional pressure, temperature, air/fuel ratio, and composition sensors, may be coupled to various locations in engine system 100. The actuators 18 may include, for example, throttle 20, EGR valve 52, diverter valve 175, wastegate actuator 92, and fuel injector 66. The control system 14 may include a controller 12. The controller 12 may receive input data from the various sensors, process the input data, and trigger various actuators in response to the processed input data based on instructions or code programmed therein corresponding to one or more routines. For example, based on engine operating conditions and EGR requirements, the controller 12 may command a signal to an actuator coupled to diverter valve 175 and to an actuator coupled to EGR valve 52 to direct exhaust to the intake manifold and/or the tailpipe via heat exchanger 176. Additionally, the controller may opportunistically diagnose diverter valve 175 for leakage during engine cold-start based on the upstream temperature profile as measured by temperature sensor 177. Further, the controller may adjust the position diverter valve 175 based on an estimated pressure upstream of the diverter valve to provide a target backpressure upstream of the diverter valve, the target backpressure selected in response to an operator requested vehicle noise adjustment. Example control routines for exhaust heat exchange system 150 control and diagnostics are described with regard to FIGS. 3, 4, and 6.

FIG. 1A shows operation of the exhaust heat exchange system 150 in a first operating mode. As such, the first operating mode represents a first setting of diverter valve 175 and EGR valve 52 that enables exhaust flow control. In the first operating mode, diverter valve 175 may be in a fully closed position, and EGR valve 52 may be in a fully closed position. When in the first operating mode, due to the first position of diverter valve 175, the entire volume of exhaust exiting second emissions control device 173 may be diverted into the bypass passage at junction 106. The exhaust may then flow through heat exchanger 176 and return to the main exhaust passage via diverter valve 175. Due to the closed position of EGR valve 52, the exhaust flowing through the bypass passage may not flow into EGR passage 180, and the entire volume of exhaust may re-enter main exhaust passage 102. After re-entering main exhaust passage 102, exhaust may flow through muffler 172 and then into the atmosphere via tailpipe 35. In embodiments where the bypass passage includes a GPF instead of the heat exchanger, during the first operating mode, all of the exhaust flowing through the bypass passage is directed through the GPF, where all of the cold-start particulate emissions are trapped, before the exhaust is released to the atmosphere via the tailpipe.

The exhaust heat exchange system may be operated in the first operating mode (as described above) during conditions when the engine requires heating, such as during engine cold-start conditions. As the exhaust passes through heat exchanger 176, heat from the exhaust may be transferred to the coolant circulating through heat exchanger 176. Upon heat transfer from the exhaust to the coolant, the hot coolant may be circulated back to and around the engine via the coolant outlet line 162. By expediting engine warm-up during cold-start, cold-start exhaust emissions may be reduced and engine performance may be increased. In addition, when the engine is coupled in a vehicle, the hot coolant may be circulated around a heater core to provide heat to a passenger cabin of the vehicle.

The exhaust heat exchange system may also be operated in the first operating mode during conditions when the air mass through the engine is lower, such as during deceleration events or during engine idling.

FIG. 1B shows a schematic view of exhaust heat exchange system 150 in a second operating mode. Components previously introduced in FIG. 1A are numbered similarly and are not reintroduced. As such, the second operating mode represents a second setting of diverter valve 175 and EGR valve 52 that enables exhaust flow control. The exhaust heat exchange system may be operated in the second operating mode when EGR is requested after engine warm-up has been completed and when exhaust heat is no longer desired for engine heating purposes. In the second operating mode, diverter valve 175 may be in the second, fully open position, and EGR valve 52 may be in an open position. Due to the fully open position of diverter valve 175, exhaust flow from bypass passage 174 to main exhaust passage 102 may be disabled. An opening of the EGR valve 52 may be adjusted to allow a desired amount of exhaust to enter bypass passage 174 and EGR delivery passage 180.

When in the second operating mode, due to the open position of both EGR valve 52 and diverter valve 175, a first portion of exhaust may be drawn from the bypass passage downstream of the heat exchanger, which acts as an EGR cooler, and delivered to the engine intake manifold via EGR delivery passage 180 and EGR valve 52. A second (remaining) portion of exhaust may flow directly to the tailpipe via muffler 172. The ratio of the first portion of exhaust (delivered to intake manifold 22) to the second portion of exhaust (directly routed to tailpipe 35 without cooling) may be determined based on a desired EGR level. EGR may be requested to attain a desired engine dilution, thereby improving fuel efficiency and emissions quality. An amount of EGR requested may be based on engine operating conditions, including engine load, engine speed, engine temperature, etc. For example, the controller may refer a look-up table having the engine speed and load as the input and a signal corresponding to a degree of opening to apply to the EGR valve as the output, the degree of opening providing a dilution amount corresponding to the input engine speed-load. In still other examples, the controller may rely on a model that correlates the change in engine load with a change in the engine's dilution requirement and further correlates the change in the engine's dilution requirement with a change in the EGR requirement. For example, as engine load increases from a low load to a mid load, EGR requirement may increase; as engine load increases from a mid load to a high load, EGR requirement may decrease.

FIG. 1C shows a schematic view of exhaust heat exchange system 150 in a third operating mode. Components previously introduced in FIG. 1A are numbered similarly and not reintroduced. The exhaust heat exchange system 150 may be operated in the third operating mode responsive to higher-than-threshold engine load conditions and after engine warm-up is completed. During such higher-than-threshold engine load conditions, EGR may not be requested. Additionally, because the engine is warm, exhaust heat recovery may not be desired. As such, the third operating mode represents a third setting of diverter valve 175 and EGR valve 52 that enables exhaust flow control. In the third operating mode, diverter valve 175 may be in the second, fully open position, and EGR valve 52 may be in the closed position. Due to the fully open position of diverter valve 175, exhaust flow from bypass passage 174 to main exhaust passage 102 may be disabled. When in the third operating mode, due to the second position of diverter valve 175 and the closed position of EGR valve 52, the entire volume of exhaust exiting second emissions control device 173 may not enter the bypass passage and may flow directly to tailpipe 35 via muffler 172. In the third operational mode, there is no exhaust flow through heat exchanger 176, so exhaust heat is not recovered.

The three example modes of operation of engine exhaust heat exchange system 150 of FIGS. 1A-1C are tabulated in FIG. 2. Line 202 of table 200 shows settings corresponding to operating the engine exhaust system in the first mode, as described with reference to FIG. 1A. Line 204 shows settings corresponding to operating the engine exhaust system in the second mode, as described with reference to FIG. 1B. Line 206 shows settings corresponding to operating the engine exhaust system in the third mode, as described with reference to FIG. 1C. In this way, the components of FIGS. 1A-1C provide for an engine system comprising:

an intake manifold; an exhaust passage including an exhaust catalyst with a particulate filter coating and a tailpipe; a bypass coupled to the exhaust passage from downstream of the exhaust catalyst to upstream of the tailpipe, the bypass including a heat exchanger; a coolant system for circulating coolant through the engine and the heat exchanger; a diverter valve coupling an outlet of the bypass to the exhaust passage; a temperature sensor and a pressure sensor coupled to the exhaust passage downstream of the exhaust catalyst and upstream of the diverter valve; an EGR passage including an EGR valve coupling the bypass, downstream of the heat exchanger, to the intake manifold; and a controller. The controller may be configured with computer-readable instructions for: operating the engine in a first mode during an engine cold-start with the diverter valve closed and the EGR valve closed; operating the engine in a second mode following catalyst light-off with the diverter valve open and the EGR valve open; operating the engine in a third mode following the catalyst light-off with the diverter valve open and the EGR valve closed; diagnosing the diverter valve while operating in the first mode; and in response to no indication of diverter valve degradation, adjusting a degree of opening of the diverter valve in each of the second mode and the third mode based on an operator exhaust noise request. In one example, diagnosing the diverter valve may include measuring a first exhaust temperature via the temperature sensor upon closing the diverter valve to operate in the first mode; measuring a second exhaust temperature via the temperature sensor after a duration of operating in the first mode; indicating degradation of the diverter valve responsive to a difference between the first temperature and the second temperature being higher than a threshold; and indicating no degradation of the diverter valve responsive to the difference being lower than the threshold. The operator exhaust noise request may include one of exhaust noise reduction and exhaust noise amplification. Accordingly, the adjusting may include estimating a target exhaust backpressure upstream of the diverter valve based on the operator exhaust noise request; decreasing a degree of opening of the diverter valve to increase the exhaust backpressure measured via the pressure sensor to the target backpressure; and increasing the degree of opening of the diverter valve to decrease the exhaust backpressure measured via the pressure sensor to the target backpressure. Additionally or optionally, when operating in the second mode, the EGR valve may be adjusted to a first position to provide an EGR flow rate; and further adjusted from the first position to a second position based on the degree of opening of the diverter valve to maintain the EGR flow rate.

FIG. 3 illustrates an example method 300 that may be implemented for adjusting exhaust flow through the engine exhaust system of FIGS. 1A-1C. Instructions for carrying out method 300 and the rest of the methods included herein may be executed by a controller based on instructions stored on a memory of the controller and in conjunction with signals received from sensors of the engine system, such as the sensors described above with reference to FIGS. 1A-1C. The controller may employ engine actuators of the engine system to adjust engine operation, according to the methods described below.

Method 300 begins at 302 and includes estimating and/or measuring engine operating conditions. Conditions assessed may include, for example, engine temperature, engine load, engine speed, driver torque demand, ambient conditions including ambient temperature, pressure, and humidity, manifold air flow and air pressure, throttle position, exhaust pressure, exhaust air/fuel ratio, etc. Operating conditions may be measured by one or more sensors communicatively coupled to a controller or may be inferred based on available data.

At 304, the method includes determining if the engine is in a cold-start condition. An engine cold-start condition may be confirmed when the engine is started responsive to an engine start request after a prolonged period of engine inactivity, while the engine temperature is lower than a threshold (such as below an exhaust catalyst light-off temperature), and while ambient temperatures are below a threshold. During cold-start conditions, expedited engine heating may be desired to reduce cold-start emissions. Additionally, passenger cabin heating may be desired by a vehicle operator. Furthermore, during an engine cold-start, EGR may not be desired.

If an engine cold-start condition is confirmed, the method progresses to 306 and includes operating the engine exhaust system in the first operating mode. Operating in the first mode, as described in reference to FIG. 1A, includes, at 308, shifting the diverter valve (such as diverter valve 175 of FIG. 1A) coupled to a junction of the bypass passage (such as bypass passage 174 of FIG. 1A) and the main exhaust passage to a fully closed position that diverts exhaust flow into the bypass passage and through an ancillary device in the bypass passage. Operating in the first mode also includes actuating the EGR valve (such as EGR valve 52 of FIG. 1A) to a closed position at 310. In one example, when the engine is shut-down and at rest, the diverter valve may be in an open position (e.g., a default position). Responsive to the engine start request, the diverter valve may be commanded closed while engine fueling is resumed and the engine is cranked.

Due to the closed position of both the diverter valve and the EGR valve, at 312, method 300 includes flowing the entire volume of exhaust exiting the catalyst to the tailpipe via the bypass passage. Due to the closed position of the EGR valve, exhaust flow from the exhaust passage to the engine intake manifold via the EGR passage is disabled. Consequently, after passing through the bypass passage, the exhaust may return to the main exhaust passage upstream of a muffler (such as muffler 172 of FIG. 1A) via the diverter valve.

In the example embodiment of FIG. 1A, a heat exchanger is housed in the bypass passage. As exhaust flows through the bypass passage and thus through the heat exchanger, heat is transferred from the exhaust to the engine coolant system. By transferring heat from the exhaust to the coolant at a location downstream of the exhaust catalyst, a bulk of the exhaust heat can be used to warm (and thereby activate) the exhaust catalyst while the remaining exhaust heat can be advantageously used to expedite engine heating. For example, the warmed coolant may be circulated to an engine block and cylinder head to raise the engine temperature, thereby improving engine performance during cold conditions. In another example, if cabin heating is requested by the vehicle operator due to the vehicle cabin temperature being lower than a desired temperature, warmed coolant may be circulated through a heater core to provide cabin heating.

In another embodiment, the bypass passage may house a gasoline particulate filter (GPF). As exhaust flows through the bypass passage and thus through the GPF, exhaust cold-start particulate matter (PM) emissions are retained in the GPF system and burned off at a later time when the GPF is regenerated. By retaining the cold-start PMs at the GPF, cold-start exhaust emissions are reduced.

Following 312, the method progresses to 314 and includes recording the temperature upstream of the exhaust diverter valve upon initiation of engine start (Tₛₜₐᵣₜ) and for a duration thereafter. For example, the exhaust temperature may be initially measured (Tₛₜₐᵣₜ) when the engine is cranked and fuel delivery to the engine is started. Alternatively, the temperature may be initially measured when the diverter valve is actuated closed responsive to the restart request. Thereafter, the engine temperature may be measured for a duration since the engine start. This includes measuring the temperature continuously over the duration or measuring the temperature intermittently over the duration, such as at predefined intervals (e.g., after a defined number of seconds/minutes, after a defined number of combustion events, after a defined distance of vehicle travel, etc.). In one example, the temperature readings may be plotted on a graph to produce a temperature profile. The exhaust temperature may be measured by a temperature sensor (e.g., temperature sensor 177 of FIG. 1A) positioned upstream of the diverter valve and downstream of a junction of the exhaust bypass passage and the main exhaust passage (e.g., junction 106 of FIG. 1A).

At 316, method 300 includes diagnosing the diverter valve based on the temperature profile estimated upstream of the diverter valve after engine start, as elaborated with reference to FIG. 4. As such, when exhaust gas is diverted into the bypass passage and routed through the ancillary device in the bypass passage, the temperature upstream of the diverter valve is not expected to rise significantly. For example, the temperature may change by a small amount, such as 4° C. However, the diverter valve may develop a leak over time due to hardware issues including wear and tear. When this occurs, a portion of the hot exhaust may start leaking into the tailpipe through the main exhaust passage without flowing through the bypass passage, causing a rise in the temperature upstream of the diverter valve. Therefore, the diverter valve may be diagnosed responsive to a higher than threshold rise in exhaust temperature measured upstream of the valve, as elaborated at FIG. 4. Further, a degree of leakage may be inferred based on the actual rise relative to the expected rise, as explained with reference to FIG. 5.

At 318, it is confirmed whether the diverter valve has been diagnosed to be not degraded and it is further determined if the temperature of the exhaust catalyst (T_{cat}) is greater than a threshold. The threshold may represent a light-off temperature of the catalyst, above which the catalyst is activated and may efficiently reduce engine exhaust emissions. Thus, if the diverter valve is determined to be functional and also if T_{cat} is greater than the threshold, it may be inferred that the vehicle is no longer in a cold-start condition, and the method progresses to 322. If T_{cat} is not greater than the threshold, or if the diverter valve is determined to be degraded, the method progresses to 320 and includes maintaining exhaust heat exchange system operation in the first operating mode. Alternatively, if T_{cat} is not greater than the threshold while the diverter valve is determined to be not degraded, the exhaust heat exchange system may be operated in the first mode. In comparison, if the diverter valve is determined to be degraded, irrespective of T_{cat}, the exhaust heat exchange system may be operated in the third mode with exhaust bypass flow disabled. Following 320, method 300 ends.

Optionally, after confirming diverter valve functionality, from each of 318 and 320, the method may move to 342 to adjust the diverter valve position to provide an operator requested exhaust noise adjustment. As described with reference to FIG. 6, a position of the functional diverter valve may be adjusted, while operating in a given mode, based on the requested noise profile to provide a target backpressure upstream of the valve, the target backpressure selected corresponding to the requested noise effect (which may include exhaust noise reduction or amplification).

Returning to 304, if it is determined that the engine is not in a cold-start condition, such as when the engine temperature is higher than the threshold or when the exhaust catalyst is already at light-off, method 300 progresses to 322 and includes determining if EGR is desired. EGR may be desired after the exhaust catalyst(s) have attained their respective light-off temperature(s) and are optimally functional. Furthermore, EGR may be requested to attain a desired engine dilution, thereby improving fuel efficiency and emissions quality. An amount of EGR requested may be based on engine operating conditions, including engine load, engine speed, engine temperature, etc. For example, the controller may refer a look-up table having the engine speed and load as the input and a signal corresponding to a degree of opening to apply to the EGR valve as the output, the degree of opening providing a dilution amount corresponding to the input engine speed-load. In still other examples, the controller may rely on a model that correlates the change in engine load with a change in the engine's dilution requirement and further correlates the change in the engine's dilution requirement with a change in the EGR requirement. For example, as engine load increases from a low load to a mid load, the EGR requirement may increase and a larger EGR valve opening may be requested. Then, as engine load increases from a mid load to a high load, the EGR requirement may decrease and a smaller EGR valve opening may be requested.

Returning to 322, if it is determined that EGR is requested for engine operation (such as for low to mid load regions), method 300 proceeds to 324 and includes operating the exhaust bypass system in the second operating mode, as described with reference to FIG. 1B. Operating in the second mode includes actuating the diverter valve to an open position at 326, determining an initial EGR valve position for the requested EGR amount at 328, and actuating the EGR valve to the initial open position at 330. The initial open position of the EGR valve is determined based on the amount of EGR requested, with the degree of EGR valve opening increased as the amount of EGR requested increases.

At 332, due to the open position of the diverter valve, the method includes flowing a first portion of exhaust to the intake manifold as EGR and a second portion of exhaust to the tailpipe via the main exhaust passage. The first portion of exhaust may enter the bypass passage from the main exhaust passage. In the example embodiment of FIG. 1B, the bypass passage houses a heat exchanger. The first portion of exhaust may flow through the heat exchanger (acting as an EGR cooler), where it is cooled. Upon exiting the heat exchanger, due to the opening of the EGR valve, the first portion of exhaust may enter the EGR delivery passage to be delivered to the engine intake manifold via the EGR valve and the engine intake passage. The first portion of exhaust may not return to the main exhaust passage due to the position of the diverter valve. The second (remaining) portion of exhaust may not enter the bypass passage but may flow directly to the tailpipe via the main exhaust passage. Following 332, the method progresses to 342 for exhaust noise control.

If EGR is not desired for engine operation at 322, the method progresses to 334 and includes operating the exhaust bypass system in a third mode, as described with reference to FIG. 1C. For example, EGR may not be desired during higher-than-threshold engine load conditions. Operating in the third mode includes actuating the diverter valve to an open position at 336 and actuating the EGR valve to a closed position at 338.

At 340, due to the open position of the diverter valve and the closed position of the EGR valve, the method includes flowing the exhaust to the tailpipe via the main exhaust passage. The entire volume of exhaust exiting the catalyst (such as second emissions control device 173 of FIG. 1C) may not enter the bypass passage and may flow directly to tailpipe 35 via muffler 172. In this operational mode, there is no exhaust flow through the bypass passage. Following 340, method 300 proceeds to 342 for exhaust noise control.

At 342, upon confirming that the diverter valve is not degraded and while operating the exhaust heat exchange system in one of the first, second, and third operating mode, it is determined if an exhaust noise adjustment is requested by a vehicle operator. For example, exhaust noise reduction may be requested to comply with Drive-by-Noise regulations or due to operator objection to exhaust noise levels. As another example, exhaust noise amplification may be requested to make the vehicle sound “sportier.” If an exhaust noise adjustment is requested, the method progresses to 344 and includes updating the exhaust diverter valve position based on the requested noise adjustment while maintaining exhaust emissions compliance, as described with reference to FIG. 6. Following 344, method 300 ends.

If, at 342, a vehicle noise adjustment is not requested, the method progresses to 346 and includes maintaining exhaust bypass system operation. For example, the position of the diverter valve may be maintained and the exhaust heat exchange system may continue to be operated in the first, second, or third operating mode. Thereby, vehicle exhaust noise is also not adjusted. Following 346, method 300 ends.

In this way, an exhaust diverter valve may be diagnosed opportunistically during an engine cold-start while an exhaust heat exchange system is operated with the diverter valve closed. By diagnosing the diverter valve before an operating mode of the exhaust heat exchange system is changed via adjustments to the position of the diverter valve, elevated tailpipe emissions from exhaust leakage past the diverter valve are reduced. In addition, exhaust noise control may be more reliably provided.

Turning now to FIG. 4, an example method 400 for diagnosing exhaust diverter valve degradation using measurements from an upstream exhaust temperature sensor is shown. The method of FIG. 4 may be included as part of the method of FIG. 3, such as at 316. The method enables leakage across the diverter valve to be reliably diagnosed, even when the bypass passage of the exhaust heat exchange system includes an ancillary device having a low backpressure, such as the heat exchanger of FIGS. 1A-1C.

Method 400 begins at 402 and includes determining if exhaust diverter valve diagnostic conditions are met. Exhaust diverter valve diagnostic conditions may be considered met when the vehicle is in a cold-start condition and the exhaust diverter valve is actuated to a closed position wherein exhaust is not flowing through the diverter valve. This includes operating the exhaust heat exchange system in the first operating mode with exhaust being diverted into the bypass passage (as described with reference to FIG. 1A). Therefore, the diagnostic routine may be performed opportunistically during an engine cold-start. If the exhaust diverter valve diagnostic conditions are not met, method 400 progresses to 404 and includes maintaining the exhaust diverter valve open. In one example, the open position of the diverter valve may be a default position of the valve when the engine is shut down and at rest. The exhaust diverter valve may also be held open when the engine is operating in the second (FIG. 1B) or third (FIG. 1C) engine operating modes. Following 404, method 400 ends.

If, at 402, the exhaust diverter valve diagnostic conditions are met, the method proceeds to 406 to diagnose the diverter valve based on an exhaust temperature measured upstream of the diverter valve. Specifically, at 406, the method includes measuring the exhaust temperature upstream of the exhaust diverter valve via a temperature sensor coupled to the exhaust passage immediately upstream of the exhaust diverter valve and downstream of the exhaust catalyst in the main exhaust passage, such as temperature sensor 177 of FIG. 1. A first exhaust temperature (Tₛₜₐᵣₜ) may be measured at the time of engine start from rest, such as when the diverter valve is commanded closed, when engine fueling is resumed and the engine is cranked. A further exhaust temperature (Tₚᵣₑₛₑₙₜ) may be measured after a duration since the estimation of the first exhaust temperature, such as after a duration since engine fueling is resumed. The duration may be a duration that ensures that a threshold number of combustion events have elapsed following a first combustion event since the engine start. Alternatively, the duration may be based on exhaust airflow, the duration increased until a defined volume of exhaust has flown through the bypass passage. Further still, the temperature may be monitored continuously over the duration or intermittently over the duration, at fixed intervals of time or combustion event number (counting from the first combustion event since the engine start). If monitored continuously or intermittently, a temperature profile may be determined by plotting the temperature data over time. It will be appreciated that the temperature is measured while the exhaust heat exchange system is operating in the first mode, with the diverter valve closed and with exhaust flowing through the bypass passage and not through the diverter valve.

At 408, the method includes determining a change in the temperature upstream of the exhaust diverter valve (ΔT) as Tₚᵣₑₛₑₙₜ−Tₛₜₐᵣₜ. This includes determining a difference between the estimated temperature values and/or estimating a slope of the temperature profile. Comparing the present (e.g., real-time) temperature after the duration has elapsed with Tₛₜₐᵣₜ normalizes the diagnostic method, making it a robust diagnostic for all drive cycles.

Turning briefly to FIG. 5, a graph 500 of example diverter valve temperature profiles is illustrated. The X-axis represents time after engine start, and the Y-axis represents the temperature upstream of the closed exhaust diverter valve and downstream of a junction of an inlet of the exhaust bypass passage and the main passage. Note that the engine is in a cold-start condition, with a low (0° C.) initial temperature (Tₛₜₐᵣₜ), represented by dashed line 502. After engine start, exhaust flow upstream of the valve is minimal with the exhaust diverter valve in the closed position due to a deadheading effect. Because exhaust flow is minimal upstream of the valve, the temperature upstream of the valve (Tₚᵣₑₛₑₙₜ) increases by a small amount (e.g., less than, a threshold amount, such as by 4° C. or less) when the valve is properly sealed, as shown by plot 504. However, an exhaust diverter valve may degrade and develop a leak over time, for example, due to wear and tear or due to an accumulation of soot that prevents the valve from fully sealing. If the exhaust diverter valve leaks while in the closed position, hot exhaust may flow through the diverter valve, thereby increasing the temperature upstream of the valve. An exhaust diverter valve with a small leak is shown at 506, and an exhaust diverter valve with a large leak is shown at 508. As the magnitude of the leak increases, the amount of exhaust gas that is routed to the bypass passage decreases, and the amount of exhaust gas flowing through the leaky valve and to the tailpipe via the main exhaust passage increases. This results in a corresponding increase in the temperature upstream of the diverter valve, as indicated at plots 506 and 508. For example, when the leak is smaller (e.g., plot 506), the temperature may rise by ˜20° C. while when the leak is larger (e.g., plot 508), the temperature may rise by ˜30° C. Therefore, the magnitude of the leak can be estimated as a function of the magnitude of the change in temperature (ΔT) from Tₛₜₐᵣₜ. In particular, as the actual temperature difference exceeds an expected temperature difference, the inferred size of the diverter valve leak may be increased.

Returning now to FIG. 4, at 410, method 400 includes determining if ΔT (as calculated at 408) is greater than a threshold. The threshold may be based on an expected rise in temperature across the diverter valve when there is no degradation. If ΔT is not greater than the threshold, method 400 progresses to 412, and no diverter valve leakage is indicated. In response to no indication of diverter valve degradation, the exhaust heat exchange system is continued to be transitioned between the first, second, and third operating modes based on engine speed-load conditions. In addition, use of the diverter valve for exhaust noise control is enabled. Following 412, method 400 ends.

Returning to 410, if ΔT is greater than the threshold, method 400 progresses to 414 and includes setting a diagnostic code to indicate that the diverter valve is degraded and inferring the degree of leakage based on the magnitude of the change in temperature (ΔT). For example, a flag indicating that the exhaust valve is leaking may be set, and the controller may refer a look-up table that uses ΔT as an input and provides a degree of leakage of the diverter valve as an output. The estimated degree of leakage may be increased as the magnitude of ΔT increases. Furthermore, one or more engine operating parameters may be adjusted based on the indication of diverter valve leakage to reduce particulate matter (PM) generation. For example, if the engine system is configured with port and direct fuel injection, the controller may adjust a split ratio of engine fueling to increase the amount of fuel delivered via port fuel injection (PFI) while decreasing the amount of fuel delivered via direct injection (DI) to reduce PM generation. The degree of change to the split ratio of PFI to DI fuel may be determined based on the magnitude of the leak. As the magnitude of the leak increases, the ratio of PFI to DI fuel may be increased. Following 414, method 400 ends.

Turning now to FIG. 6, an example method 600 for adjusting vehicle exhaust noise by changing the position of the exhaust diverter valve (e.g., exhaust diverter valve 175 of FIGS. 1A-1C) is shown. The method of FIG. 6 may be included as part of the method of FIG. 3, such as at 344. The method enables an exhaust backpressure upstream of a diverter valve to be adjusted to tune the exhaust noise characteristics to a desired exhaust noise profile. In this way, an existing diverter valve may be leveraged for exhaust noise control, reducing the reliance on dedicated devices.

Method 600 begins at 602 and includes receiving an exhaust noise adjustment request from a vehicle operator. For example, the vehicle operator may desire a noise reduction to make the vehicle run quieter. As another example, the vehicle operator may request a noise amplification to make the vehicle sound “sportier.”

At 604, the method includes determining if exhaust diverter valve degradation is indicated based on the diagnostics of the diverter valve, as described with reference to FIG. 4. If diverter valve degradation is indicated, the method proceeds to 606, and vehicle noise is not adjusted using the exhaust diverter valve. With the exhaust diverter valve degraded, exhaust noise control via the diverter valve may be temporarily disabled. Following 606, method 600 ends.

If no degradation is indicated at 604, method 600 progresses to 608. At 608, the method includes calculating an exhaust backpressure that will produce the desired change in exhaust noise. Exhaust backpressure refers to the pressure upstream of the exhaust diverter valve, for example, as measured by a pressure sensor coupled to the exhaust passage upstream of the diverter valve and downstream of the exhaust catalyst (e.g., pressure sensor 178 of FIGS. 1A-1C). Exhaust backpressure may be increased by closing the exhaust diverter valve. As the degree of valve closing increases, the exhaust backpressure increases. Further, as exhaust backpressure increases, the exhaust pressure downstream of the exhaust diverter valve decreases, creating a pressure loss across the valve. This in turn reduces exhaust noise by attenuating the exhaust pulses flowing through the tailpipe. The controller may refer a look-up table having the desired exhaust noise as the input and the exhaust backpressure required to produce the desired exhaust noise as the output. In another example, the controller may rely on a model that correlates a change in exhaust noise with a change in exhaust backpressure.

At 610, the method includes determining the exhaust diverter valve position that will produce the desired backpressure (as determined at 608). As described above, the exhaust backpressure increases as the exhaust diverter valve is actuated from a fully open position to a fully closed position. Thus, the exhaust diverter valve may produce the desired backpressure in a partially closed position. An initial exhaust diverter valve position may be determined in a feed-forward manner. For example, the controller may refer a look-up table having the desired exhaust backpressure as the input and the exhaust diverter valve position required to produce the desired exhaust backpressure as the output. In another example, the controller may rely on a model that correlates an exhaust backpressure with an exhaust diverter valve position. Following 610, method 600 progresses to 612.

At 612, it is determined if EGR flow from the bypass passage into the EGR passage and thereon to the intake manifold will be affected by adjusting the exhaust diverter valve position. For example, the vehicle may be operated in an EGR mode to provide a requested EGR dilution based on engine speed-load conditions, as described with reference to FIG. 1B. Therein, the diverter valve and the EGR valve are held open with a degree of opening of the EGR valve adjusted to enable an amount of exhaust corresponding to the requested engine dilution to be drawn into the EGR passage via the bypass passage. If the diverter valve position is changed, and thereby the degree of opening of the diverter valve is changed, the amount of exhaust flowing through the bypass passage and into the EGR delivery passage (such as EGR delivery passage 180 of FIG. 1B) may also change. As such, this may affect the engine dilution, and thereby exhaust emissions. As an example, if the diverter valve position is changed to increase exhaust backpressure, the portion of exhaust flowing to the tailpipe via the exhaust bypass passage may increase due to the pressure loss across the exhaust diverter valve, and the portion of exhaust flowing from the exhaust bypass passage to the engine intake manifold via the EGR delivery passage may decrease. As another example, if the diverter valve position is changed to decrease exhaust backpressure, the portion of exhaust flowing to the tailpipe via the exhaust bypass passage may decrease while the portion of exhaust flowing from the exhaust bypass passage to the engine intake manifold via the EGR delivery passage may increase.

If it is determined that EGR will be affected by the diverter valve adjustment, at 614, the method includes determining an updated EGR valve position based on the diverter valve adjustment in order to maintain EGR flow. For example, if the portion of exhaust flowing through the EGR delivery passage is expected to decrease in response to the change in diverter valve position, to compensate for the unintended decrease, an updated EGR valve position having a greater degree of opening relative to the initial EGR valve position may be determined to maintain the requested EGR flow and engine dilution. As another example, if the portion of exhaust flowing through the EGR delivery passage is expected to increase in response to the change in diverter valve position, to compensate for the unintended increase, an updated EGR valve position having a decreased degree of opening relative to the initial EGR valve position may be determined to maintain the requested EGR flow and engine dilution. Following 614, method 600 progresses to 616.

At 616, it is determined if the updated EGR valve position and determined diverter valve position are within system constraints. System constraints may include, for example, emissions and vehicle noise requirements. For example, it may be determined if either the determined diverter valve position or updated EGR valve position will cause exhaust emissions to exceed a threshold. System constrains may further include physical limits of the hardware. For example, it may be determined if the EGR valve or the diverter valve are currently at a hardware limit (e.g., fully open or fully closed) from where the updated EGR valve position or diverter valve position adjustment are not physically possible. As an example, if the diverter valve is already fully closed, a further increase in exhaust backpressure by further closing the diverter valve is not possible. As another example, if the diverter valve is already fully open, a further decrease in exhaust backpressure by further opening the diverter valve is not possible. Likewise, if the EGR valve is already fully open (or fully closed), an updated EGR valve position that makes the EGR valve more open (or more closed) is not possible. If the updated EGR valve position and updated exhaust diverter valve position are not within system constraints, at 618 the method includes maintaining the diverter valve position and maintaining the initial EGR valve position. At this time, because the diverter valve position is not adjusted, vehicle exhaust noise is also not adjusted. As a result, the operator requested vehicle exhaust noise adjustment is not met due to system constraints (e.g., emissions constraints or physical limitations). Following 618, method 600 ends.

Returning to 616, if the updated EGR valve position and updated exhaust diverter valve position are within system constraints, and therefore feasible, the method progresses to 620 and includes adjusting the diverter valve and the EGR valve to the determined (updated) positions to produce the desired exhaust noise. That is, the diverter valve is actuated to the position determined at 610, and the EGR valve is actuated to the position determined at 614. As a result, the operator requested vehicle exhaust noise adjustment is met via adjustments to the diverter valve and corresponding adjustments to the EGR valve. Following 620, the method progresses to 632.

At 632, method 600 includes measuring the actual exhaust backpressure, for example, via a pressure sensor upstream of the diverter valve. At 634, the method includes feedback adjusting the diverter valve position based on the estimated exhaust backpressure (as estimated at 632) relative to the target exhaust backpressure (as determined at 608). For example, if the estimated pressure is greater than the target backpressure, the diverter valve may be adjusted to a more open position, with the change in position determined based on the change in backpressure that will achieve the target exhaust backpressure. As another example, if the estimated pressure is less than the target backpressure, the diverter valve may be adjusted to a less open position. Following 634, method 600 ends.

In the example engine system 100 of FIGS. 1A-1C, EGR is disabled in the first (FIG. 1A) and third (FIG. 1C) operating modes, and thus, EGR would not be affected by a change in exhaust diverter valve position. Returning to 612, if EGR will not be affected by adjusting the exhaust diverter valve position, at 626, the method includes determining if the updated diverter valve position is within system constraints, as described in reference to 616. If the updated diverter valve position is not within system constraints, the method proceeds to 628 and includes maintaining the diverter valve position. Because the diverter valve is not adjusted, vehicle noise is also not adjusted. Following 628, method 600 ends.

If, at 626, the updated diverter valve position is within system constraints, the method progresses to 630 and includes adjusting the diverter valve position to produce the desired exhaust noise. That is, the diverter valve is actuated to the position determined at 610. The diverter valve may be opened by a larger amount to provide a smaller backpressure when the operator exhaust noise demand includes noise amplification, and the diverter valve may be opened by a smaller amount to provide a larger backpressure when the operator exhaust noise demand includes noise reduction. Following 630, method 600 proceeds to 632 to measure the actual exhaust backpressure after adjusting the diverter valve and then to 634 to feedback adjust the position of the diverter valve based on a difference between the measure backpressure and the target backpressure, as described earlier.

In this way, using a closed-loop controller, exhaust backpressure may be used to continuously fine tune the exhaust diverter valve position to produce an operator requested effect on vehicle exhaust noise.

Graph 700 of FIG. 7 displays an example timing diagram illustrating diagnosis of an exhaust diverter valve in an engine system of a vehicle (such as engine system 100 of FIGS. 1A-1C) during an engine cold-start. Graph 700 also illustrates how the position of the diverter valve may be adjusted to regulate exhaust noise. Engine speed is shown at plot 702; a requested EGR amount is shown at plot 704; EGR valve position is shown at plot 706; exhaust diverter valve position is shown at plot 708; catalyst temperature is shown at plot 710; exhaust noise is shown at plot 712; exhaust backpressure is shown at plot 714; a change in exhaust temperature over a duration since an engine start (ΔT), as estimated upstream of the diverter valve, is shown at plot 716; and a flag indicating diverter valve degradation is shown at plot 718. Additionally, a temperature threshold for catalyst light-off is represented at dashed line 720, and a ΔT threshold for diagnosing diverter valve leakage is represented at dashed line 722. For all of the above plots, the X-axis represents time, with time increasing along the X-axis from left to right. The Y-axis of each individual plot corresponds to the labeled parameter, with the value increasing from bottom to top, with the exceptions of plots 706 and 708, in which the Y-axis represents valve position (with “closed” referring to fully closed and “open” referring to fully open), and plot 718, in which the Y-axis reflects whether a diverter valve diagnostic flag is set or not (“on” or “off”).

Prior to t1, the engine is shut down and at rest (plot 702). As no exhaust is produced with the engine at rest, the pressure upstream of the exhaust diverter valve and downstream of the exhaust catalyst (plot 714) is at atmospheric pressure, and there is no exhaust noise (plot 712). Furthermore, the catalyst is at ambient temperature (plot 710). In the present example, the ambient temperature is low. While the engine is at rest, the exhaust diverter valve may be held open, as indicated at plot 708.

At t1, responsive to a key-on event, an engine start command is inferred, and the diverter valve is closed (plot 708) before cranking the engine. By closing the diverter valve, the exhaust system is operated in a first operating mode, as described with reference to FIG. 1A. Fuel is then delivered to the engine cylinders to start the engine. Engine speed (plot 702) may start to increase due to fuel being combusted as the engine is spun, responsive to driver demand. Due to the ambient temperature being lower than a threshold at the time of the engine start, the catalyst is below its activation temperature, and the engine start at t1 is inferred to be an engine cold-start.

Between t1 and t2, as engine combustion progresses, the temperature of the catalyst (plot 710) starts to rise while remaining below the temperature threshold for catalyst light-off (dashed line 720). Thus, while the vehicle is in a cold-start condition, the vehicle exhaust system is operated in a first operating mode, as described with reference to FIG. 1A. With the exhaust diverter valve in the fully closed position (plot 708), the entire volume of exhaust exiting the catalyst may be diverted into a bypass passage housing an ancillary emissions device. In the example of FIG. 1A, the ancillary emissions device is a heat exchanger (e.g., heat exchanger 176). EGR is not requested during the cold-start (plot 704), and the EGR valve remains fully closed (plot 706). Furthermore, with the vehicle in a cold-start condition and the diverter valve fully closed, the controller may initiate diagnosis of the exhaust diverter valve.

With the exhaust diverter valve fully closed, the exhaust backpressure upstream of the diverter valve increases, as shown by plot 714. Due to a deadheading effect of the fully closed exhaust diverter valve, ΔT upstream of the diverter valve (plot 716) increases by an insignificant amount and remains below threshold 722. As described herein, ΔT refers to the change in the exhaust temperature upstream of the diverter valve since an engine start and is calculated as Tₚᵣₑₛₑₙₜ−Tₛₜₐᵣₜ, with Tₛₜₐᵣₜ corresponding to the exhaust temperature at the engine start and Tₚᵣₑₛₑₙₜ corresponding to the temperature after a duration. In the example of FIG. 7, Tₚᵣₑₛₑₙₜ is measured continuously by a temperature sensor upstream of the diverter valve and downstream of the exhaust bypass inlet (e.g., temperature sensor 177 of FIG. 1A), and ΔT is plotted over time. Because ΔT is lower than threshold 722, the diverter valve diagnostic flag remains off (plot 718), indicating that the exhaust diverter valve is not degraded. As shown by dashed segment 715a, if the diverter valve were degraded and leaking, the exhaust backpressure would be lower compared with the backpressure created by a functional (not leaking) diverter valve (plot 714) due to exhaust flowing through the diverter valve. As a result of hot exhaust flowing through the degraded diverter valve, the magnitude of ΔT upstream of the diverter valve, as indicated by dashed segment 717, would be greater than for a functional diverter valve (plot 716). In such a case, in response to dashed segment 717 crossing threshold 722 between t1 and t2, a diverter valve diagnostic flag would be indicated (as shown at dashed segment 719).

At t2, T_{cat} (plot 710) reaches the catalyst light-off temperature (dashed line 720), and the engine exits the cold-start condition. Responsive to catalyst light-off, the exhaust diverter valve is commanded open (plot 708). Between t2 and t3, the engine speed (plot 702) increases to a mid speed-load range, responsive to a change in driver demand (e.g., due to an operator pedal tip-in), and EGR is requested (plot 704). Responsive to the EGR demand, the exhaust system is transitioned to the second operating mode, wherein the EGR valve is actuated to a first, partially open position (plot 706), with the degree of opening determined based on the requested EGR dilution.

With the diverter valve open, the exhaust backpressure upstream of the diverter valve decreases (plot 714). This causes an increase in exhaust noise (plot 712). Furthermore, the change in temperature upstream of the diverter valve increases as a portion of exhaust flows through the diverter valve and to the tailpipe via the main exhaust passage (and through the diverter valve). Although ΔT surpasses threshold 722 between t2 and t3, the diverter valve diagnostic flag remains off (plot 718) because the entry conditions for diagnosing the diverter valve are not met (e.g., the diverter valve is open).

At t3, responsive to a vehicle noise reduction request from the driver, the diverter valve is actuated to a partially closed position. The degree of valve closing is determined based on the exhaust backpressure required to produce the desired reduction in vehicle noise. With the exhaust diverter valve partially closed, the exhaust backpressure (plot 714) increases, and ΔT upstream of the diverter (plot 716) valve decreases. As a result of the pressure differential across the partially closed diverter valve, the exhaust noise decreases (plot 712). In order to compensate for the change in exhaust diverter valve position (and thus, a change in the amount of exhaust flowing through the bypass passage to the EGR delivery passage), the EGR valve is actuated to an open position with a greater degree of opening than the original EGR valve open position, as shown at plot 706.

At t4, responsive to a further increase in driver demand, the engine speed (plot 702) transitions to a high speed-load range where engine dilution is not required. Therefore, EGR is disabled (plot 704) by transitioning the engine exhaust system to a third operating mode. As described with reference to FIG. 1C, in the third operating mode, EGR is disabled by actuating the EGR valve to the fully closed position, as shown by plot 706. While operating in the third operating mode, the exhaust diverter valve is actuated to the fully open position (plot 708). With the diverter valve fully open, the exhaust backpressure upstream of the diverter valve decreases (plot 714). The entire volume of exhaust may flow to the tailpipe via the main exhaust passage, causing ΔT upstream of the diverter valve (and downstream of the exhaust bypass junction) to increase.

At t5, the engine speed (plot 702) is reduced to a low-mid speed-load, responsive to a drop in driver demand. As a result, the engine exhaust system is transitioned to the second operating mode (as described with reference to FIG. 1B), and EGR is requested (plot 704). The amount of EGR requested at t5 may be higher than the amount requested between t2 and t4, and thus, the EGR valve may be opened to a greater degree at t5. In the depicted example, between t5 and t6, the EGR valve is actuated to the fully open position. In response to operating in the second operating mode, the exhaust diverter valve remains in the fully open position (plot 708).

At t6, an exhaust noise reduction request is received from the driver, as indicated by dashed segment 713. To provide the requested noise reduction, the diverter valve would be adjusted to a more closed position and the EGR valve would be adjusted to a more open position to compensate for the change in EGR flow due to the diverter valve adjustment. However, with the EGR valve already fully open (plot 706), the EGR valve cannot be further opened to maintain the EGR flow following the requested diverter valve adjustment (plot 704). Therefore at this time, instead of actuating the diverter valve to a partially closed position (dashed segment 709) to provide the requested noise reduction, the exhaust diverter valve is maintained fully open (plot 708). With the exhaust diverter valve fully open, the exhaust backpressure remains low (plot 714), as it is not possible to provide the desired increase in backpressure (dashed segment 715b) and remain within system constraints. The desired noise reduction request (dashed segment 713) is not met in this scenario, and the exhaust noise remains elevated (plot 712).

In this way, an exhaust diverter valve used to route exhaust to a bypass passage housing an ancillary exhaust after-treatment device may be opportunistically diagnosed for degradation during an engine cold-start, while the exhaust diverter valve is fully closed, instead of operating the exhaust system in a dedicated diagnostics operating mode. By relying on the output of an exhaust temperature sensor positioned upstream of the exhaust diverter valve and downstream of an inlet of the bypass passage, as well as by normalizing the exhaust temperature measured at engine start, a robust diagnosis of the diverter valve may be enabled with a high signal-to-noise ratio. Further, if the diverter valve is degraded, a magnitude of leakage may be estimated based on the temperature profile upstream of the diverter valve, and engine operating conditions may be adjusted based on the magnitude of the leak. By addressing exhaust diverter valve degradation reliably and early during a vehicle drive cycle, cold-start and unintended exhaust emissions may be reduced. Additionally, the same exhaust diverter valve may be leveraged to regulate vehicle exhaust noise instead of a dedicated noise regulating device. As such, this provides component cost and complexity reduction benefits.

In one example, a method for an engine is provided, comprising, responsive to an engine cold-start condition, operating with a diverter valve closed to divert exhaust gas from a main exhaust passage, downstream of an exhaust catalyst, into a bypass housing an ancillary device; and indicating degradation of the diverter valve based on a change in exhaust temperature determined upstream of the diverter valve for a duration since engine start. In the preceding example, additionally or optionally, the exhaust temperature is determined via a temperature sensor coupled to the main exhaust passage upstream of the diverter valve and downstream of the exhaust catalyst. In any or all of the preceding examples, the method may additionally or optionally comprise, after light-off of the exhaust catalyst, adjusting operation of the diverter valve responsive to an operator exhaust noise request. In any or all of the preceding examples, additionally or optionally, the adjusting includes, after determining no indicated degradation of the diverter valve, increasing an opening of the diverter valve when the operator exhaust noise request includes noise amplification, and decreasing an opening of the diverter valve when the operator exhaust noise request includes noise reduction. In any or all of the preceding examples, additionally or optionally, the adjusting further includes adjusting a degree of opening of the diverter valve to provide a target exhaust backpressure upstream of the diverter valve, the target exhaust backpressure based on the operator exhaust noise request. In any or all of the preceding examples, the ancillary device may additionally or optionally include one of a heat exchanger and a particulate matter filter. In any or all of the preceding examples, additionally or optionally, the indicating includes indicating degradation responsive to a higher than threshold difference between the exhaust temperature determined upon initiation of the engine start and the exhaust temperature determined after the duration since the engine start, the threshold difference based on a mass of exhaust diverted from the main exhaust passage into the bypass during the engine cold-start condition. In any or all of the preceding examples, additionally or optionally, indicating degradation includes indicating diverter valve leakage, the method further comprising, estimating a size of a leakage across the diverter valve based on the higher than threshold difference, the size of the leakage increased as a magnitude of the difference increases. In any or all of the preceding examples, additionally or optionally, the ancillary device is a heat exchanger fluidly coupled to an engine coolant line, the method further comprising, responsive to the indication of degradation, disabling coolant flow to the heat exchanger via the coolant line. In any or all of the preceding examples, additionally or optionally, the method further comprises, after light-off of the exhaust catalyst, opening the diverter valve, and recirculating exhaust gas from the bypass, downstream of the heat exchanger, to an engine intake manifold via an EGR passage housing an EGR valve.

Another example method comprises, while an engine is at rest, holding open a diverter valve coupling a main exhaust passage to a bypass housing a heat exchanger; responsive to an engine start, closing the diverter valve before cranking the engine; diagnosing the diverter valve based on an exhaust temperature measured upstream of the diverter valve at the closing of the diverter valve and after a duration of operating with the diverter valve closed; and in response to no indication of diverter valve degradation, adjusting the diverter valve based on operator exhaust noise demand. In the preceding example, additionally or optionally, the method further comprises diverting exhaust from the main exhaust passage to the bypass and through the heat exchanger via the closing of the diverter valve, circulating coolant through the heat exchanger, and transferring heat from the diverted exhaust to the circulating coolant at the heat exchanger; and in response to an indication of diverter valve degradation, disabling coolant flow through the heat exchanger and actuating the diverter valve open. In any or all of the preceding examples, additionally or optionally, the diverter valve is coupled upstream of a junction of an outlet of the bypass and the main exhaust passage, wherein the exhaust temperature is measured via a temperature sensor coupled downstream of a junction of an inlet of the bypass and the main exhaust passage, and wherein exhaust is diverted into the bypass from downstream of an exhaust catalyst having a particulate matter filter coating. In any or all of the preceding examples, additionally or optionally, adjusting the diverter valve includes, after the exhaust catalyst has reached a light-off temperature, opening the diverter valve by an amount to provide an exhaust backpressure upstream of the diverter valve, the exhaust backpressure based on the operator exhaust noise demand, the diverter valve opened by a larger amount to provide a smaller backpressure when the operator exhaust noise demand includes noise amplification, the diverter valve opened by a smaller amount to provide a larger backpressure when the operator exhaust noise demand includes noise reduction. In any or all of the preceding examples, additionally or optionally, the method further comprises, with the diverter valve open, opening an EGR valve to recirculate exhaust from the bypass, downstream of the heat exchanger, to an intake manifold via an EGR passage, a degree of opening of the EGR valve adjusted based on the opening of the diverter valve to meet an engine dilution demand. In any or all of the preceding examples, additionally or optionally, the diagnosing includes indicating no degradation of the diverter valve when the exhaust temperature measured upstream of the diverter valve after the duration of operating with the diverter valve closed exceeds the exhaust temperature measured at the closing by less than a first threshold amount; indicating degradation of the diverter valve with a smaller leak when the exhaust temperature measured upstream of the diverter valve after the duration exceeds the exhaust temperature measured at the closing by more than the first threshold amount and less than a second threshold amount, the second threshold amount larger than the first threshold amount; and indicating degradation of the diverter valve with a larger leak when the exhaust temperature measured upstream of the diverter valve after the duration exceeds the exhaust temperature measured at the closing by more than the second threshold amount.

Another example system for a vehicle comprises an engine including an intake manifold; an exhaust passage including an exhaust catalyst with a particulate filter coating and a tailpipe; a bypass coupled to the exhaust passage from downstream of the exhaust catalyst to upstream of the tailpipe, the bypass including a heat exchanger; a coolant system for circulating coolant through the engine and the heat exchanger; a diverter valve coupling an outlet of the bypass to the exhaust passage; a temperature sensor and a pressure sensor coupled to the exhaust passage downstream of the exhaust catalyst and upstream of the diverter valve; an EGR passage including an EGR valve coupling the bypass, downstream of the heat exchanger, to the intake manifold; and a controller with computer-readable instructions for: operating the engine in a first mode during an engine cold-start with the diverter valve closed and the EGR valve closed; operating the engine in a second mode following catalyst light-off with the diverter valve open and the EGR valve open; operating the engine in a third mode following the catalyst light-off with the diverter valve open and the EGR valve closed; diagnosing the diverter valve while operating in the first mode; and in response to no indication of diverter valve degradation, adjusting a degree of opening of the diverter valve in each of the second mode and the third mode based on an operator exhaust noise request. In the preceding example, additionally or optionally, diagnosing the diverter valve includes measuring a first exhaust temperature via the temperature sensor upon closing the diverter valve to operate in the first mode; measuring a second exhaust temperature via the temperature sensor after a duration of operating in the first mode; indicating degradation of the diverter valve responsive to a difference between the first temperature and the second temperature being higher than a threshold; and indicating no degradation of the diverter valve responsive to the difference being lower than the threshold. In any or all of the preceding examples, additionally or optionally, the operator exhaust noise request includes one of exhaust noise reduction and exhaust noise amplification, and wherein the adjusting includes estimating a target exhaust backpressure upstream of the diverter valve based on the operator exhaust noise request; decreasing a degree of opening of the diverter valve to increase the exhaust backpressure measured via the pressure sensor to the target backpressure; and increasing the degree of opening of the diverter valve to decrease the exhaust backpressure measured via the pressure sensor to the target backpressure. In any or all of the preceding examples, additionally or optionally, the controller includes further instructions for: when operating in the second mode, adjusting the EGR valve to a first position to provide an EGR flow rate; and further adjusting the EGR valve from the first position to a second position based on the degree of opening of the diverter valve to maintain the EGR flow rate.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for an engine, comprising:
responsive to an engine cold-start condition, operating with a diverter valve closed to divert exhaust gas from a main exhaust passage, downstream of an exhaust catalyst, into a bypass housing an ancillary device; and
indicating degradation of the diverter valve based on a change in exhaust temperature determined upstream of the diverter valve for a duration since engine start.

2. The method of claim 1, wherein the exhaust temperature is determined via a temperature sensor coupled to the main exhaust passage upstream of the diverter valve and downstream of the exhaust catalyst.

3. The method of claim 1, further comprising, after light-off of the exhaust catalyst, adjusting operation of the diverter valve responsive to an operator exhaust noise request.

4. The method of claim 3, wherein the adjusting includes, after determining no indicated degradation of the diverter valve, increasing an opening of the diverter valve when the operator exhaust noise request includes noise amplification, and decreasing an opening of the diverter valve when the operator exhaust noise request includes noise reduction.

5. The method of claim 4, wherein the adjusting further includes adjusting a degree of opening of the diverter valve to provide a target exhaust backpressure upstream of the diverter valve, the target exhaust backpressure based on the operator exhaust noise request.

6. The method of claim 1, wherein the ancillary device includes one of a heat exchanger and a particulate matter filter.

7. The method of claim 6, wherein the indicating includes indicating degradation responsive to a higher than threshold difference between the exhaust temperature determined upon initiation of the engine start and the exhaust temperature determined after the duration since the engine start, the threshold difference based on a mass of exhaust diverted from the main exhaust passage into the bypass during the engine cold-start condition.

8. The method of claim 7, wherein indicating degradation includes indicating diverter valve leakage, the method further comprising, estimating a size of a leakage across the diverter valve based on the higher than threshold difference, the size of the leakage increased as a magnitude of the difference increases.

9. The method of claim 8, wherein the ancillary device is a heat exchanger fluidly coupled to an engine coolant line, the method further comprising, responsive to the indication of degradation, disabling coolant flow to the heat exchanger via the coolant line.

10. The method of claim 3, further comprising, after light-off of the exhaust catalyst, opening the diverter valve, and recirculating exhaust gas from the bypass, downstream of the heat exchanger, to an engine intake manifold via an EGR passage housing an EGR valve.

11. A method, comprising:
while an engine is at rest, holding open a diverter valve coupling a main exhaust passage to a bypass housing a heat exchanger;
responsive to an engine start, closing the diverter valve before cranking the engine;
diagnosing the diverter valve based on an exhaust temperature measured upstream of the diverter valve at the closing of the diverter valve and after a duration of operating with the diverter valve closed; and
in response to no indication of diverter valve degradation, adjusting the diverter valve based on operator exhaust noise demand.

12. The method of claim 11, further comprising, diverting exhaust from the main exhaust passage to the bypass and through the heat exchanger via the closing of the diverter valve, circulating coolant through the heat exchanger, and transferring heat from the diverted exhaust to the circulating coolant at the heat exchanger; and in response to an indication of diverter valve degradation, disabling coolant flow through the heat exchanger and actuating the diverter valve open.

13. The method of claim 12, wherein the diverter valve is coupled upstream of a junction of an outlet of the bypass and the main exhaust passage, wherein the exhaust temperature is measured via a temperature sensor coupled downstream of a junction of an inlet of the bypass and the main exhaust passage, and wherein exhaust is diverted into the bypass from downstream of an exhaust catalyst having a particulate matter filter coating.

14. The method of claim 13, wherein adjusting the diverter valve includes, after the exhaust catalyst has reached a light-off temperature, opening the diverter valve by an amount to provide an exhaust backpressure upstream of the diverter valve, the exhaust backpressure based on the operator exhaust noise demand, the diverter valve opened by a larger amount to provide a smaller backpressure when the operator exhaust noise demand includes noise amplification, the diverter valve opened by a smaller amount to provide a larger backpressure when the operator exhaust noise demand includes noise reduction.

15. The method of claim 14, further comprising, with the diverter valve open, opening an EGR valve to recirculate exhaust from the bypass, downstream of the heat exchanger, to an intake manifold via an EGR passage, a degree of opening of the EGR valve adjusted based on the opening of the diverter valve to meet an engine dilution demand.

16. The method of claim 11, wherein the diagnosing includes:
indicating no degradation of the diverter valve when the exhaust temperature measured upstream of the diverter valve after the duration of operating with the diverter valve closed exceeds the exhaust temperature measured at the closing by less than a first threshold amount;
indicating degradation of the diverter valve with a smaller leak when the exhaust temperature measured upstream of the diverter valve after the duration exceeds the exhaust temperature measured at the closing by more than the first threshold amount and less than a second threshold amount, the second threshold amount larger than the first threshold amount; and
indicating degradation of the diverter valve with a larger leak when the exhaust temperature measured upstream of the diverter valve after the duration exceeds the exhaust temperature measured at the closing by more than the second threshold amount.

17. An engine system, comprising:
an engine including an intake manifold;
an exhaust passage including an exhaust catalyst with a particulate filter coating and a tailpipe;
a bypass coupled to the exhaust passage from downstream of the exhaust catalyst to upstream of the tailpipe, the bypass including a heat exchanger;
a coolant system for circulating coolant through the engine and the heat exchanger;
a diverter valve coupling an outlet of the bypass to the exhaust passage;
a temperature sensor and a pressure sensor coupled to the exhaust passage downstream of the exhaust catalyst and upstream of the diverter valve;
an EGR passage including an EGR valve coupling the bypass, downstream of the heat exchanger, to the intake manifold; and
a controller with computer-readable instructions for:
operating the engine in a first mode during an engine cold-start with the diverter valve closed and the EGR valve closed;
operating the engine in a second mode following catalyst light-off with the diverter valve open and the EGR valve open;
operating the engine in a third mode following the catalyst light-off with the diverter valve open and the EGR valve closed;
diagnosing the diverter valve while operating in the first mode; and
in response to no indication of diverter valve degradation, adjusting a degree of opening of the diverter valve in each of the second mode and the third mode based on an operator exhaust noise request.

18. The system of claim 17, wherein diagnosing the diverter valve includes:
measuring a first exhaust temperature via the temperature sensor upon closing the diverter valve to operate in the first mode;
measuring a second exhaust temperature via the temperature sensor after a duration of operating in the first mode;
indicating degradation of the diverter valve responsive to a difference between the first temperature and the second temperature being higher than a threshold; and
indicating no degradation of the diverter valve responsive to the difference being lower than the threshold.

19. The system of claim 17, wherein the operator exhaust noise request includes one of exhaust noise reduction and exhaust noise amplification, and wherein the adjusting includes:
estimating a target exhaust backpressure upstream of the diverter valve based on the operator exhaust noise request;
decreasing a degree of opening of the diverter valve to increase the exhaust backpressure measured via the pressure sensor to the target backpressure; and
increasing the degree of opening of the diverter valve to decrease the exhaust backpressure measured via the pressure sensor to the target backpressure.

20. The system of claim 18, wherein the controller includes further instructions for:
when operating in the second mode,
adjusting the EGR valve to a first position to provide an EGR flow rate; and
further adjusting the EGR valve from the first position to a second position based on the degree of opening of the diverter valve to maintain the EGR flow rate.
